(19) United States
(12) Patent Application Publication
(10) Pub. No.: US 2019/0311373 A1
(43) Pub. Date: Oct. 10, 2019

(54) SYSTEM AND METHOD OF TAKING OVER CUSTOMER SERVICE

(71) Applicant: Hitachi, Ltd., Tokyo (JP)

(72) Inventor: Michiko YOSHIDA, San Jose, CA (US)

(73) Assignee: Hitachi, Ltd.

(21) Appl. No.: 15/945,551

(22) Filed: Apr. 4, 2018

(51) Int. Cl. G06Q 30/00; G06N 3/00; G06K 9/00

(52) U.S. Cl. CPC G06Q 30/016; G06K 9/00288; G06N 3/008

(57) ABSTRACT

Example implementations are directed to systems and methods that involve obtaining, at a first service robot from a plurality of service robots, data regarding one or more types of services to be executed by one or more second service robots from the plurality of service robots, in response to a human interacting with the first service robot; selecting the one or more second service robots from the plurality of service robots to execute the one or more types of services; and instructing the selected one or more second service robots to execute the one or more types of services.

### BACKGROUND

### Field

The present disclosure is generally directed to customer service systems, and more specifically, to customer service handover to designated robots.

### Related Art

According to the progress of artificial intelligence (AI) related technology, many online customer service systems are adopting robots to proceed customer services. In general, such a customer service system comprises a service robot and a human service end. In one related art implementation, there is a customer service system in which a robot receives a request from a customer, determines whether it is capable of processing it, and either takes over the request to conduct the human customer service, or end the connection if the system cannot proceed with the request.

In the related art, there is a rising adoption of service robots. The main purposes of such robots involve providing product information to a customer or conducting a question and answer session. Eventually, such service robots will be expected to provide a more sophisticated service such as personalized concierge service at hotel. In such cases, multiple robots will have to cooperate with each other, due to the costs associated with deploying multi-function robots. Instead, multiple single-functioned robots are typically employed.

### SUMMARY

If one robot is incapable of conducting customer service, the robot needs to handover customer service responsibilities to another robot. In such situations, the robot should take in information that the other robot cannot normally intake from the customer, and send such information to the other robot. For example, the other robot may require information about the customer and identification credentials so that the other robot can identify the correct customer when providing the customer service.

Example implementations described herein involve the handover/takeover of customer from a first robot to a second robot which includes taking in service information that is available or receivable by the first robot, but not necessarily available to the second robot. Such information can include customer identification information which the first robot has the equipment or means to acquire from the customer and that the second robot has the equipment or means to conduct identification from the customer identification information.

Aspects of the present disclosure can involve a method, which can involve obtaining, at a first service robot from a plurality of service robots, data regarding one or more types of services to be executed by one or more second service robots from the plurality of service robots, in response to a human interacting with the first service robot; selecting the one or more second service robots from the plurality of service robots to execute the one or more types of services; and instructing the selected one or more second service robots to execute the one or more types of services.

Aspects of the present disclosure can also include a non-transitory computer readable medium, storing instructions for executing a process, the instructions involving obtaining, at a first service robot from a plurality of service robots, data regarding one or more types of services to be executed by one or more second service robots from the plurality of service robots, in response to a human interacting with the first service robot; selecting the one or more second service robots from the plurality of service robots to execute the one or more types of services; and instructing the selected one or more second service robots to execute the one or more types of services.

Aspects of the present disclosure can also include a service robot, which can include a processor, configured to: obtain data regarding one or more types of services to be executed by one or more other service robots from a plurality of service robots, in response to a human interacting with the service robot; select the one or more other service robots from the plurality of service robots to execute the one or more types of services; and instruct the selected one or more other service robots to execute the one or more types of services.

Aspects of the present disclosure can involve a system, which can involve means for obtaining data regarding one or more types of services to be executed by one or more service robots from the plurality of service robots, in response to a human interacting with the system; means for selecting the one or more service robots from the plurality of service robots to execute the one or more types of services; and means for instructing the selected one or more service robots to execute the one or more types of services.

Aspects of the present disclosure can involve a system, which can involve a processor, configured to obtain data regarding one or more types of services to be executed by one or more service robots from the plurality of service robots, in response to a human interacting with the system; select the one or more service robots from the plurality of service robots to execute the one or more types of services; and instruct the selected one or more service robots to execute the one or more types of services.

### BRIEF DESCRIPTION OF DRAWINGS

FIG. 1 illustrates an example system, upon which example implementations as described herein may be implemented.

FIG. 2 shows an example of Robot Capability Manager, in accordance with an example implementation.

FIG. 3 illustrates an example flow for having a first robot select a second robot for taking over customer service responsibilities, in accordance with an example implementation.

FIG. 4 shows an example of Robot Capability Manager in accordance with another example implementation.

FIG. 5 illustrates an example flow according to another example implementation.

FIG. 6 illustrates an example flow, in accordance with another example implementation.

FIG. 7 illustrates an example hardware diagram for a service robot, in accordance with an example implementation.

FIG. 8 illustrates an example computing environment with an example computer device suitable for use in some example implementations.

### DETAILED DESCRIPTION

The following detailed description provides further details of the figures and example implementations of the present application. Reference numerals and descriptions of redundant elements between figures are omitted for clarity. Terms used throughout the description are provided as examples and are not intended to be limiting. For example, the use of the term “automatic” may involve fully automatic or semi-automatic implementations involving user or administrator control over certain aspects of the implementation, depending on the desired implementation of one of ordinary skill in the art practicing implementations of the present application. Selection can be conducted by a user through a user interface or other input means, or can be implemented through a desired algorithm. Example implementations as described herein can be utilized either singularly or in combination and the functionality of the example implementations can be implemented through any means according to the desired implementations.

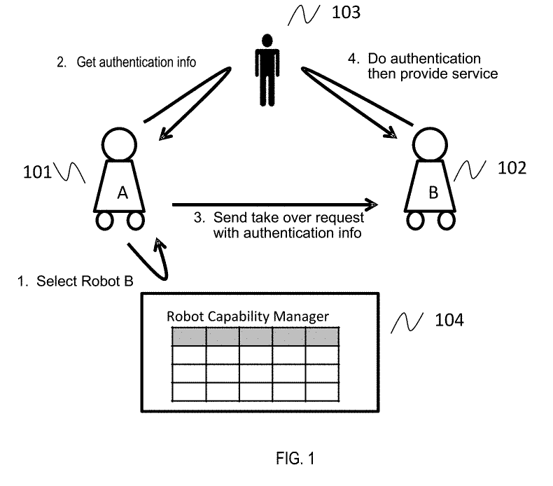

FIG. 1 illustrates an example system, upon which example implementations as described herein may be implemented. Robot Capability Manager (104) is configured to manage the capabilities and the functionalities of the robots. In the example of FIG. 1, robot A (101) and robot B (102) provides service to a customer (103) by having the customer service responsibilities taken over by robot B (102) from robot A (101).

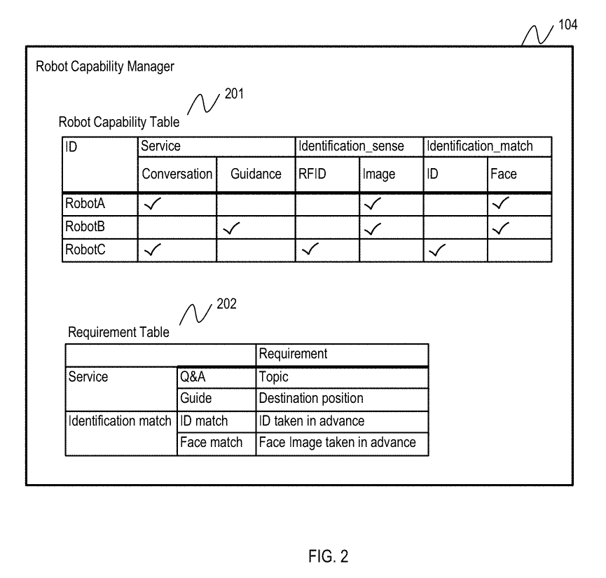

FIG. 2 shows an example of Robot Capability Manager (104), in accordance with an example implementation. Robot Capability Manager (104) includes a Robot Capability Table (201), which contains the identifier (ID) and capabilities of each robot under management. Although the Robot Capability Table (201) in this example has six example capabilities (“Service-Conversation”, “Service-Guidance”, “Identification_sense-RFID”, “Identification_sense-Image”, “Identification_match-ID” and “Identification_match-Face”), the capabilities are not limited to these six capabilities and any other capability can be in the Robot Capability Table (201) in accordance with the desired implementation and the desired service to be provided. Further, although the Robot Capability Table (201) is illustrated in table format, the format is not limited to the table format and it can be in the form of Extensible Markup Language (XML), Javascript Object Notation (JSON) or any other format and can be stored in a file, database or on any other storage method in accordance with the desired implementation. Requirement Table (202) contains entries indicating the requirements to execute each capability. Although the Capability Requirement Table (202) in this example is written as a table format, the format is not limited to the table format and it can be XML, JSON or any other format and can be stored in a file, database or any other storage method in accordance with the desired implementation. When each robot is registered to the system, the capabilities of the robot are registered to the Robot Capability Table (201). When a new capability is registered to the system, the requirements are registered to Requirement Table (202).

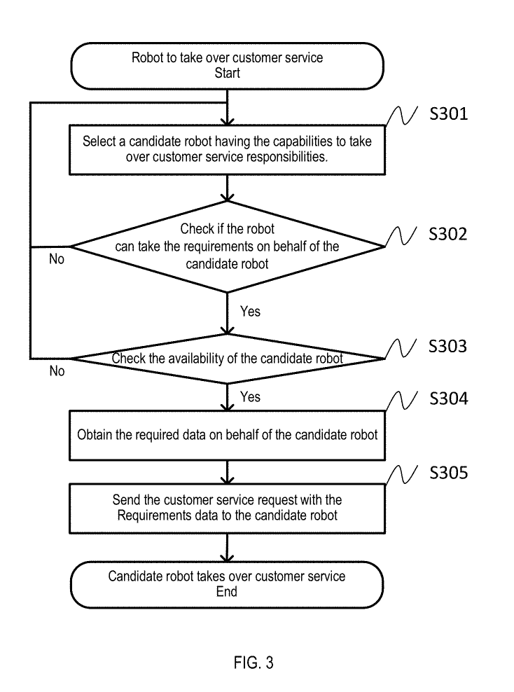

FIG. 3 illustrates an example flow for having a first robot select a second robot for taking over customer service responsibilities, in accordance with an example implementation. In an example implementation of FIG. 1, if a robot such as robotA (101) is requested to guide the customer (103) to his hotel room, robotA (101) needs to handover the customer service responsibilities to another robot if robotA (101) does not have the capability to conduct guidance services for the customer (103). In this case, the customer service is taken over by another robot that has the capabilities of “Service-guide” to guide the customer (103) to the correct hotel room and “Identificatio_match” to identify the customer (103). The customer service can also include a service level to be performed as determined by customer attributes or any other indexes depending on the desired implementation. Then, robotA (101) selects a candidate robot which has the capabilities to facilitate the needed customer service (S301). In this case, robotA (101) checks Robot Capability Table (201) and selects robotB (102) as a candidate robot as it has the capabilities to do “Service-guide” and “Identification_match”. Then robotA (101) checks the requirements (e.g., required data) needed by robotB (102) to take over the customer service, and also checks if it can fulfill such requirements for robotB (102) at S302. If it cannot (No), then the flow proceeds to S301 to select a different robot for the handover. Otherwise (Yes), the flow proceeds to S303.

In this case, robotA (101) checks Requirement Table (202) and determines that the requirements needed by robotB (102) include the “Destination position” (e.g., for determining the correct hotel room) and “Face image taken in advance” (e.g., to identify the customer). As robotB (102) is not configured to obtain such data from the customer, robotA (101) checks if it can obtain such data on behalf of robotB (102). If so (Yes), then the flow proceeds to S304, otherwise (No), the flow proceeds back to S301 to select a different robot.

In this example, robotA (101) can obtain such data on behalf of robotB (102), and obtains a face image for customer identification, and also obtains the destination hotel room. Then robotA (101) checks the availability of robotB (102) at S303. If robotB (102) is available, then robotA (101) fulfills the requirements by interacting with customer (103) to obtain the information at S304. In this case, robotA (101) already knows the hotel room of the customer and thereby knows the destination location, but robotA (101) does not have an image of the customer (103) for facial recognition. Thus, robotA (101) interacts with customer (103) and obtains the image of the customer for facial recognition through any desired implementation (e.g., taking picture with camera, obtaining facial image from database, etc.). Then, robotA (101) sends the destination position and the facial image of the customer (103) to robotB (102) at S305.

Then robotB (102) proceeds to take over the customer service responsibilities, which in this case is to conduct an identification match of the customer (103) and guide the customer (103) to the hotel room.

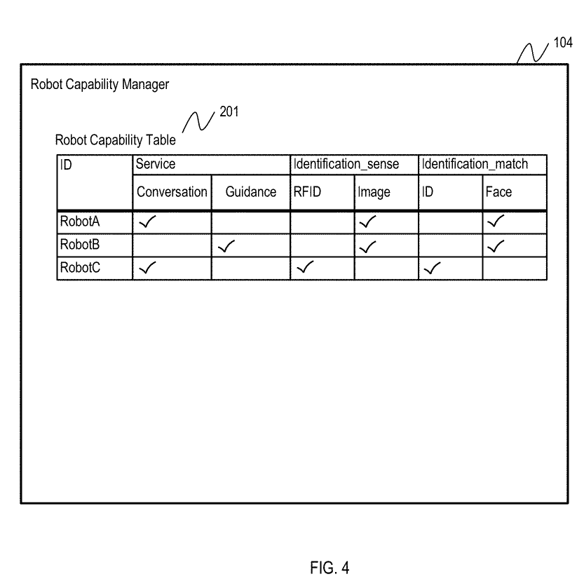

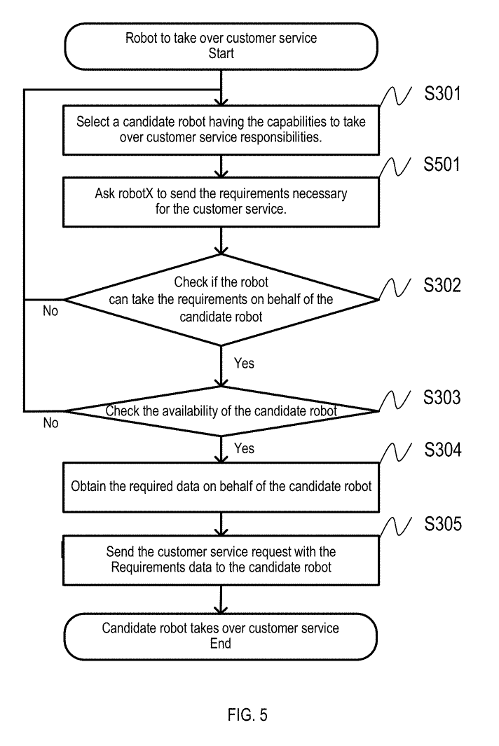

In another example implementation, the Robot Capability Manager (104) does not need to manage the requirements for the customer services. Instead, the candidate robot can indicate the required information needed to take over the customer service responsibilities. FIG. 4 shows an example of Robot Capability Manager (104) in accordance with such an example implementation. Robot Capability Manager (104) has Robot Capability Table (201) and omits the Requirement Table (202). FIG. 5 illustrates an example flow according to this example implementation. In this example, the flow is the same as that of FIG. 3 with a different step at S501. At S501, robotA (101) asks robotB (102) to send the requirements necessary for robotB (102) to take over the customer service responsibilities at S501.

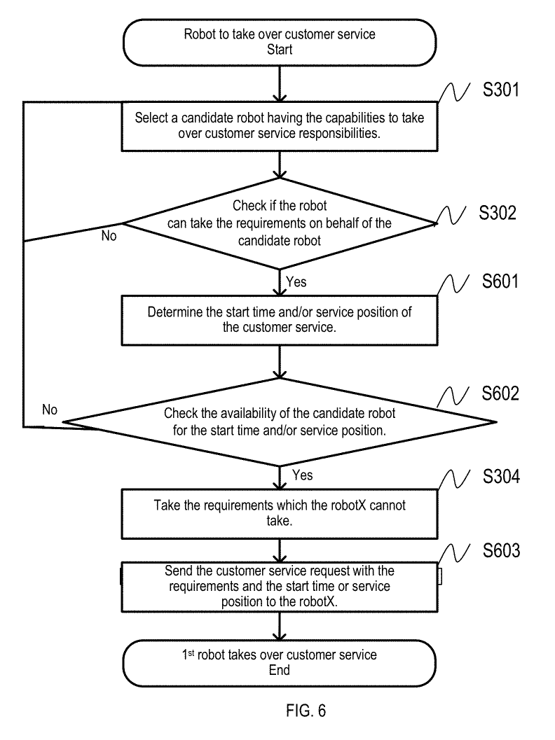

In another example implementation, a robot can take over customer service which will be conducted at a different time or different location. FIG. 6 illustrates an example flow, in accordance with this example implementation. The flow of FIG. 6 is the same as the flow of FIG. 3, with new steps S601, S602, and S603. In this example implementation, robotA (101) determines the start time and/or the service position (S601). For example, if robotA (101) is located at stationA and receives a request from a customer (103) to guide him from stationB to the hotel after the customer (103) arrives at stationB, robotA (101) needs to hand over the customer request to another robot. In this case, robotA (101) estimates the arrival time of the customer according to any desired implementation (e.g., by input from the customer, based on distance between stations, etc.). Then, robotA (101) checks the availability of robotB (102) for taking over the customer service responsibilities based on the estimated service start time and station as the service start position (S602). If robotB (102) is available (Yes), then robotA (101) sends the customer service request with the requirements, start time, and/or service start position to robotB (102) at S603. Otherwise (No), the flow proceeds back to S301 to select another candidate robot.

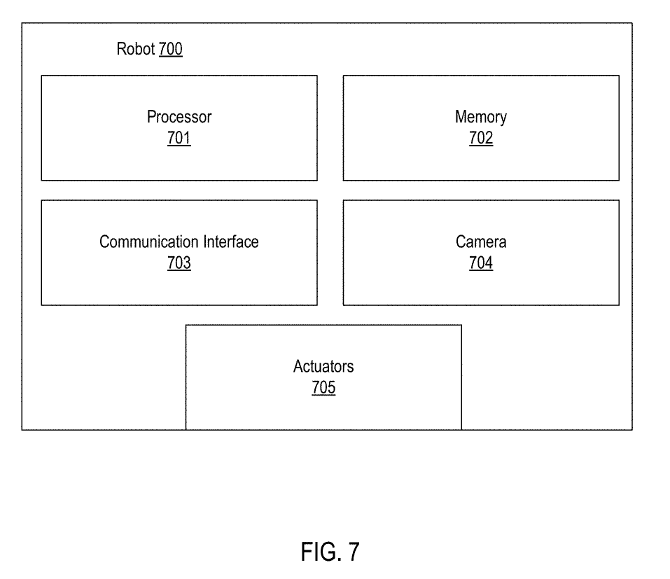

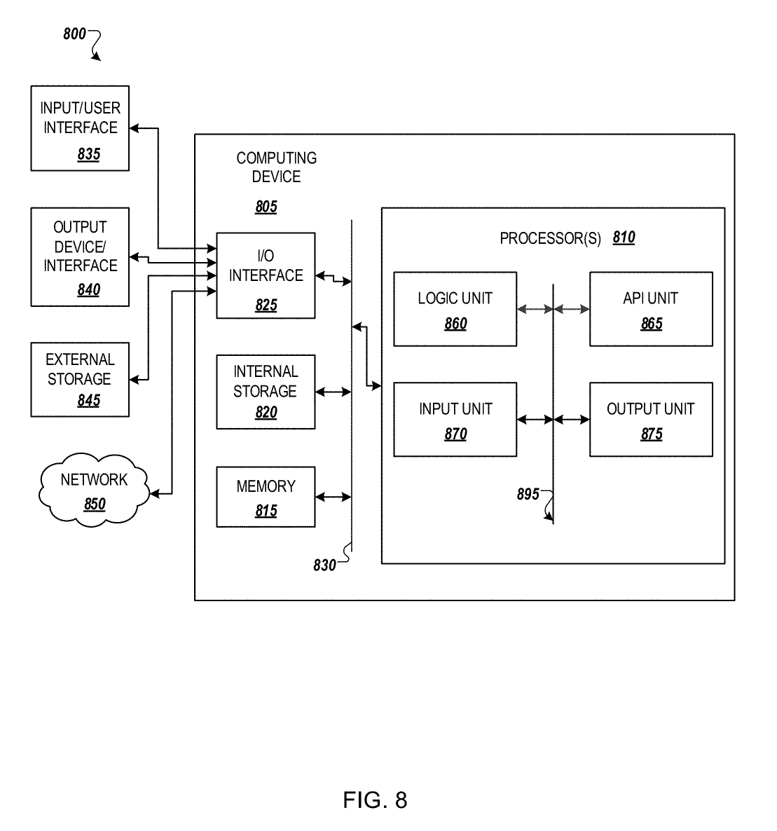

FIG. 7 illustrates an example hardware diagram for a service robot, in accordance with an example implementation. The service robot 700 may include a processor 701, a memory 702, a communication interface with a baseband processor 703, one or more sensors 704, and one or more actuators 705. Memory 702 may store instructions that can be loaded into processor 701 to execute the flow diagram as illustrated, for example, in FIGS. 3, 5 and 6, and also be configured to manage Robot Capability Manager (104) as illustrated in FIGS. 2 and 4. Communication interface 703 may be configured to receive instructions from the apparatus of FIG. 8 or from another service robot 700, and store the instructions into memory 702 for execution by the processor. The one or more sensors 704 can include cameras such as 360 degree cameras or wide angle cameras to obtain camera images suitable for conducting facial recognition, which can be processed by processor 701 locally for facial recognition, or sent back to the apparatus of FIG. 8 through the communication interface 703 for authentication. Actuators 705 can be configured to navigate and move the service robot 700 according to the desired implementation (e.g., wheel based actuators, tread based actuators, etc.). In example implementations, the service robot 700 can be a movable robot, but other implementations are also possible depending on the desired implementation, and the system of FIG. 8 can manage a plurality of service robots with different hardware configurations depending on the services and interaction with human customers intended. For example, the service robot 700 can be in the form of a kiosk, in the form of a wheeled platform for carrying luggage, in the form of a cart that escorts the human customer to another location, or through any other hardware configuration in accordance with the desired implementation.

Processor 701 can be configured to obtain data regarding one or more types of services to be executed by one or more other service robots from a plurality of service robots in contact with service robot 700 and in response to a human customer interacting with the service robot 700. The interaction can be conducted via an input interface such as a touch interface, a voice activated interface, and so on depending on the desired implementation. The data can involve customer authentication data to authenticate the human customer, such as login, facial recognition data, data read from an account card, and so on depending on the desired implementation. Further, the processor 701 can be configured to select one or more other service robots from the plurality of service robots to execute the one or more types of services. Such types of services can include escorting the human customer from one destination to another, for making a reservation, registering a hotel room, carrying luggage, and so on depending on the desired implementation. Processor 701 can then instruct the selected one or more other service robots to execute the one or more types of services through communication interface 703.

In response to receiving instructions to execute another one or more types of services from another service robot, processor 701 can be configured to contact the human interacting with the another service robot. Such contact can include conducting a message over wireless connection (e.g., text, voice message, e-mail, etc.) via baseband processor 703, though a public address system, through the service robot interacting with the human, or through other methods in accordance with the desired implementation. The processor 701 can also authenticate the human based on authentication information received from the another service robot, which can include receiving information for conducting voice recognition, facial recognition, biometric recognition, Radio Frequency Identification (RFID) login information, card reader information, and any other information needed to execute any type of authentication method in accordance with the desired implementation. Processor 701 can be configured to execute the another one or more types of services in response to the authentication being successful (e.g., conducting the desired authentication method and verifying the identity of the human).

Examples of instructions that can be sent by service robot 700 to other service robots via processor 701 and baseband process or 703 can include conducting guidance for the human, can include instructing the one or more other service robots to escort the human from a first location to a second location. Such implementations can include physically guiding the human by approaching the human and moving from the location of the human to the destination location while indicating for the human to follow along.

Processor 701 can also be configured to obtain the data regarding the one or more types of services to be executed by identifying the human and the one or more types of services needed for the human based on customer information obtained from the data; and selecting the one or more types of services based on the received customer information. Such customer information can include services levels (e.g., tier level of service to be provided to a customer based on membership, loyalty points, etc.), hotel registration information, meal or travel reservations, and so on depending on the desired implementation.

Processor 701 can also be configured to select the one or more other service robots from the plurality of service robots to execute the one or more types of services by identifying, from the plurality of service robots, the one or more other service robots configured to execute the selected services as described, and selecting the one or more other service robots configured to execute the selected services based on availability as described with respect to FIGS. 2-6.

Further, any of the functionalities as described in FIG. 7, in singular or in any combination, can also be conducted by a computing device that manages such service robots, as described with respect to FIG. 8.

FIG. 8 illustrates an example computing environment with an example computer device suitable for use in some example implementations, such as an apparatus to facilitate the functionality of managing service robots such as Robot Capability Manager (104). Computer device 805 in computing environment 800 can include one or more processing units, cores, or processors 810, memory 815 (e.g., RAM, ROM, and/or the like), internal storage 820 (e.g., magnetic, optical, solid state storage, and/or organic), and/or I/O interface 825, any of which can be coupled on a communication mechanism or bus 830 for communicating information or embedded in the computer device 805.

Computer device 805 can be communicatively coupled to input/user interface 835 and output device/interface 840. Either one or both of input/user interface 835 and output device/interface 840 can be a wired or wireless interface and can be detachable. Input/user interface 835 may include any device, component, sensor, or interface, physical or virtual, that can be used to provide input (e.g., buttons, touch-screen interface, keyboard, a pointing/cursor control, microphone, camera, braille, motion sensor, optical reader, and/or the like). Output device/interface 840 may include a display, television, monitor, printer, speaker, braille, or the like. In some example implementations, input/user interface 835 and output device/interface 840 can be embedded with or physically coupled to the computer device 805. In other example implementations, other computer devices may function as or provide the functions of input/user interface 835 and output device/interface 840 for a computer device 805.

Examples of computer device 805 may include, but are not limited to, highly mobile devices (e.g., smartphones, devices in vehicles and other machines, devices carried by humans and animals, and the like), mobile devices (e.g., tablets, notebooks, laptops, personal computers, portable televisions, radios, and the like), and devices not designed for mobility (e.g., desktop computers, other computers, information kiosks, televisions with one or more processors embedded therein and/or coupled thereto, radios, and the like).

Computer device 805 can be communicatively coupled (e.g., via I/O interface 825) to external storage 845 and network 850 for communicating with any number of networked components, devices, and systems, including one or more computer devices of the same or different configuration. Computer device 805 or any connected computer device can be functioning as, providing services of, or referred to as a server, client, thin server, general machine, special-purpose machine, or another label.

I/O interface 825 can include, but is not limited to, wired and/or wireless interfaces using any communication or I/O protocols or standards (e.g., Ethernet, 802.11x, Universal System Bus, WiMax, modem, a cellular network protocol, and the like) for communicating information to and/or from at least all the connected components, devices, and network in computing environment 800. Network 850 can be any network or combination of networks (e.g., the Internet, local area network, wide area network, a telephonic network, a cellular network, satellite network, and the like).

Computer device 805 can use and/or communicate using computer-usable or computer-readable media, including transitory media and non-transitory media. Transitory media include transmission media (e.g., metal cables, fiber optics), signals, carrier waves, and the like. Non-transitory media include magnetic media (e.g., disks and tapes), optical media (e.g., CD ROM, digital video disks, Blu-ray disks), solid state media (e.g., RAM, ROM, flash memory, solid-state storage), and other non-volatile storage or memory.

Computer device 805 can be used to implement techniques, methods, applications, processes, or computer-executable instructions in some example computing environments. Computer-executable instructions can be retrieved from transitory media, and stored on and retrieved from non-transitory media. The executable instructions can originate from one or more of any programming, scripting, and machine languages (e.g., C, C++, C#, Java, Visual Basic, Python, Perl, JavaScript, and others).

Processor(s) 810 can execute under any operating system (OS) (not shown), in a native or virtual environment. One or more applications can be deployed that include logic unit 860, application programming interface (API) unit 865, input unit 870, output unit 875, and inter-unit communication mechanism 895 for the different units to communicate with each other, with the OS, and with other applications (not shown). The described units and elements can be varied in design, function, configuration, or implementation and are not limited to the descriptions provided.

In some example implementations, when information or an execution instruction is received by API unit 865, it may be communicated to one or more other units (e.g., logic unit 860, input unit 870, output unit 875). In some instances, logic unit 860 may be configured to control the information flow among the units and direct the services provided by API unit 865, input unit 870, output unit 875, in some example implementations described above. For example, the flow of one or more processes or implementations may be controlled by logic unit 860 alone or in conjunction with API unit 865. The input unit 870 may be configured to obtain input for the calculations described in the example implementations, and the output unit 875 may be configured to provide output based on the calculations described in example implementations.

Some portions of the detailed description are presented in terms of algorithms and symbolic representations of operations within a computer. These algorithmic descriptions and symbolic representations are the means used by those skilled in the data processing arts to convey the essence of their innovations to others skilled in the art. An algorithm is a series of defined steps leading to a desired end state or result. In example implementations, the steps carried out require physical manipulations of tangible quantities for achieving a tangible result.

Unless specifically stated otherwise, as apparent from the discussion, it is appreciated that throughout the description, discussions utilizing terms such as “processing,” “computing,” “calculating,” “determining,” “displaying,” or the like, can include the actions and processes of a computer system or other information processing device that manipulates and transforms data represented as physical (electronic) quantities within the computer system's registers and memories into other data similarly represented as physical quantities within the computer system's memories or registers or other information storage, transmission or display devices.

Example implementations may also relate to an apparatus for performing the operations herein. This apparatus may be specially constructed for the required purposes, or it may include one or more general-purpose computers selectively activated or reconfigured by one or more computer programs. Such computer programs may be stored in a computer readable medium, such as a computer-readable storage medium or a computer-readable signal medium. A computer-readable storage medium may involve tangible mediums such as, but not limited to optical disks, magnetic disks, read-only memories, random access memories, solid state devices and drives, or any other types of tangible or non-transitory media suitable for storing electronic information. A computer readable signal medium may include mediums such as carrier waves. The algorithms and displays presented herein are not inherently related to any particular computer or other apparatus. Computer programs can involve pure software implementations that involve instructions that perform the operations of the desired implementation.

Various general-purpose systems may be used with programs and modules in accordance with the examples herein, or it may prove convenient to construct a more specialized apparatus to perform desired method steps. In addition, the example implementations are not described with reference to any particular programming language. It will be appreciated that a variety of programming languages may be used to implement the teachings of the example implementations as described herein. The instructions of the programming language(s) may be executed by one or more processing devices, e.g., central processing units (CPUs), processors, or controllers.

As is known in the art, the operations described above can be performed by hardware, software, or some combination of software and hardware. Various aspects of the example implementations may be implemented using circuits and logic devices (hardware), while other aspects may be implemented using instructions stored on a machine-readable medium (software), which if executed by a processor, would cause the processor to perform a method to carry out implementations of the present application. Further, some example implementations of the present application may be performed solely in hardware, whereas other example implementations may be performed solely in software. Moreover, the various functions described can be performed in a single unit, or can be spread across a number of components in any number of ways. When performed by software, the methods may be executed by a processor, such as a general purpose computer, based on instructions stored on a computer-readable medium. If desired, the instructions can be stored on the medium in a compressed and/or encrypted format.

Moreover, other implementations of the present application will be apparent to those skilled in the art from consideration of the specification and practice of the teachings of the present application. Various aspects and/or components of the described example implementations may be used singly or in any combination. It is intended that the specification and example implementations be considered as examples only, with the true scope and spirit of the present application being indicated by the following claims.

What is claimed is:

1. A method, comprising:
obtaining, at a first service robot from a plurality of service robots, data regarding one or more types of services to be executed by one or more second service robots from the plurality of service robots, in response to a human interacting with the first service robot;
selecting the one or more second service robots from the plurality of service robots to execute the one or more types of services; and
instructing the selected one or more second service robots to execute the one or more types of services.

2. The method of claim 1, further comprising, in response to the instructing the selected one or more second service robots to execute the one or more types of services:
contacting the human interacting with the first service robot with the one or more selected second service robots;
authenticating the human with the one or more selected second service robots based on authentication information received from the first service robot; and
executing the one or more types of services in response to the authenticating being successful.

3. The method of claim 2, wherein the authenticating the human comprises conducting facial recognition.

4. The method of claim 1, wherein the one or more types of services comprises conducting guidance for the human, wherein the instructing the selected one or more second service robots to execute the one or more types of service comprises instructing the one or more second service robots to escort the human from a first location to a second location.

5. The method of claim 1, wherein the obtaining the data regarding the one or more types of services to be executed comprises:
identifying, with the first service robot, the human and the one or more types of services needed for the human based on customer information obtained from the data; and
selecting the one or more types of services based on the received customer information.

6. The method of claim 1, wherein the selecting the one or more second service robots from the plurality of service robots to execute the one or more types of services comprises:
identifying, from the plurality of service robots, the one or more second service robots configured to execute the selected services, and
selecting the one or more second service robots configured to execute the selected services based on availability.

7. A non-transitory computer readable medium, storing instructions for executing a process, the instructions comprising:
obtaining, at a first service robot from a plurality of service robots, data regarding one or more types of services to be executed by one or more second service robots from the plurality of service robots, in response to a human interacting with the first service robot;
selecting the one or more second service robots from the plurality of service robots to execute the one or more types of services; and
instructing the selected one or more second service robots to execute the one or more types of services.

8. The non-transitory computer readable medium of claim 7, the instructions further comprising, in response to the instructing the selected one or more second service robots to execute the one or more types of services:
contacting the human interacting with the first service robot with the one or more selected second service robots;
authenticating the human with the one or more selected second service robots based on authentication information received from the first service robot; and
executing the one or more types of services in response to the authenticating being successful.

9. The non-transitory computer readable medium of claim 8, wherein the authenticating the human comprises conducting facial recognition.

10. The non-transitory computer readable medium of claim 7, wherein the one or more types of services comprises conducting guidance for the human, wherein the instructing the selected one or more second service robots to execute the one or more types of service comprises instructing the one or more second service robots to escort the human from a first location to a second location.

11. The non-transitory computer readable medium of claim 7, wherein the obtaining the data regarding the one or more types of services to be executed comprises:
identifying, with the first service robot, the human and the one or more types of services needed for the human based on customer information obtained from the data; and
selecting the one or more types of services based on the received customer information.

12. The non-transitory computer readable medium of claim 7, wherein the selecting the one or more second service robots from the plurality of service robots to execute the one or more types of services comprises:
identifying, from the plurality of service robots, the one or more second service robots configured to execute the selected services, and
selecting the one or more second service robots configured to execute the selected services based on availability.

13. A service robot, comprising:
a processor, configured to:
obtain data regarding one or more types of services to be executed by one or more other service robots from a plurality of service robots, in response to a human interacting with the service robot;
select the one or more other service robots from the plurality of service robots to execute the one or more types of services; and
instruct the selected one or more other service robots to execute the one or more types of services.

14. The service robot of claim 13, wherein in response to receiving instructions to execute another one or more types of services from another service robot, the processor is configured to:
contact the human interacting with the another service robot;
authenticate the human based on authentication information received from the another service robot; and
execute the another one or more types of services in response to the authentication being successful.

15. The service robot of claim 14, further comprising a camera, wherein the processor is configured to conduct authentication of the human through conducting facial recognition from the camera.

16. The service robot of claim 13, wherein the one or more types of services comprises conducting guidance for the human, wherein the processor is configured to instruct to execute the one or more types of service comprises instructing the one or more other service robots to escort the human from a first location to a second location.

17. The service robot of claim 13, wherein the processor is configured to obtain the data regarding the one or more types of services to be executed by:
identifying the human and the one or more types of services needed for the human based on customer information obtained from the data; and
selecting the one or more types of services based on the received customer information.

18. The service robot of claim 13, wherein the processor is configured to select the one or more other service robots from the plurality of service robots to execute the one or more types of services by:
identifying, from the plurality of service robots, the one or more other service robots configured to execute the selected services, and
selecting the one or more other service robots configured to execute the selected services based on availability.
